(19) United States
(12) Patent Application Publication
(10) Pub. No.: US 2013/0276822 A1
(43) Pub. Date: Oct. 24, 2013

(54) Hyperbaric methods and systems for rinsing and drying granular materials

(71) Applicant: ADVANCED WET TECHNOLOGIES GMBH, Huefingen (DE)

(72) Inventor: Richard W. Plavidal, Milpitas, CA (US)

(73) Assignee: Advanced Wet Technologies GmbH, Huefingen (DE)

(21) Appl. No.: 13/865,208

(22) Filed: Apr. 18, 2013

Related U.S. Application Data
(60) Provisional application No. 61/635,284, filed on Apr. 18, 2012.

(51) Int. Cl. B08B 3/04; B08B 3/08; F26B 5/14

(52) U.S. Cl. CPC B08B 3/04; F26B 5/14; B08B 3/08
USPC 134/3; 34/389; 134/25.1; 134/104.2

(57) ABSTRACT

Polysilicon granules can be cleaned, rinsed and dried by hyperbaric superheated liquid and superheated steam. The superheated liquid can be used to rinse and heating the polysilicon granules. A slow drain can be open to remove the superheated liquid. A fast drain then can be open, preferably to atmosphere, to allow steam to vent through bottom. The fast drain can function as a drying process, vaporizing water droplets down the drain with the escaping steam.

This application claims priority from U.S. provisional patent application Ser. No. 61/635,284, filed on Apr. 18, 2012, entitled “Hyperbaric methods and systems for granular polysilicon rinsing and drying”, which is incorporated herein by reference.

### BACKGROUND

Parts or devices with complex shapes pose a special challenge for cleaning due to small openings, internal dead spaces, blind holes and other hard to access places within the part. Traditional sprays and sonic agitation cannot access these areas effectively and even if they could it would be difficult or impossible to remove loosened debris and contaminated cleaning solutions from these parts. Even complex manifold flow connections cannot effectively flush contamination from trapped areas and dead spaces within some parts.

Continuous-feed Czochrolski ingot growing furnaces require a continuous supply of granulated (crushed) polysilicon that has been acid washed and rinsed for maximum purity before feeding it into the furnace. There is a need to dry the granulated polysilicon quickly, efficiently, and without re-contaminating the material. This gets more difficult as the polysilicon is ground into finer pieces. Finer granules facilitate better furnace performance but present a challenge to dry since finer granules retain a higher percentage of water.

### SUMMARY

In some embodiments, methods and apparatuses are provided for rinsing and drying silicon-containing granules using hyperbaric pressure liquid or gas. Superior rinsing and drying can be achieved in a suitably configured hyperbaric chamber system using saturated or superheated steam or water. In addition, chemicals can be added to improve the cleaning process.

In some embodiments, a rinsing and drying process comprises loading polysilicon granules into a hyperbaric chamber. The chamber can be pre-filled and purged with steam superheated steam or nitrogen to remove air that could oxidize silicon. Afterward, the chamber is filled to full pressure with steam from a supply reservoir. The superheated water is then introduced in shower mode to rinse and continue heating polysilicon. After the chamber and the polysilicon reach a desired temperature, a slow drain is open to remove excess water. When the liquid drainage is complete, a fast drain is open, preferably to atmosphere, to allow steam to vent through bottom. The drying process can comprise vaporization of water droplets and/or direct displacement of trapped water, e.g., in droplet forms, down the drain with the escaping steam.

### BRIEF DESCRIPTION OF THE DRAWINGS

FIG. 1 illustrates an exemplary granulated polysilicon according to some embodiments.

FIGS. 2A-2B illustrate exemplary configurations for practicing hyperbaric pressure processes according to some embodiments.

FIGS. 3A-3H illustrate an exemplary sequence of preparing granulated polysilicon according to some embodiments.

FIG. 4 illustrates an exemplary system configuration for a hyperbaric process according to some embodiments.

FIG. 5A-5B illustrate different views of an exemplary assembly line to process granulated polysilicon according to some embodiments.

FIG. 6 illustrates a flow chart for a polysilicon granule cleaning process according to some embodiments.

FIG. 7 illustrates another flow chart for a polysilicon granule cleaning process according to some embodiments.

FIG. 8 illustrates an exemplary flow chart for a hyperbaric process for cleaning, rinsing and drying granulated polysilicon according to some embodiments.

### DETAILED DESCRIPTION OF THE EMBODIMENTS

The development of CNX (Cycle Nucleation Technology) represented a breakthrough in addressing the aforementioned problem. With CNX it was possible to grow and collapse vapor bubbles in a vacuum environment which would displace fluids and dislodge contamination from hidden surfaces independent of boundary layers and geometries which would otherwise block any cleaning agitation or displacement. A key attribute of CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface.

In some embodiments, methods and apparatuses of hyperbaric CNX for rinsing and drying granules, such as silicon-containing granules, polysilicon granules, glass or quart fragments, are provided. Superior rinsing and drying can be achieved in a suitably configured H-CNX (hyperbaric CNX) system using saturated or superheated steam or water. In addition, chemicals can be added to improve results or to add cleaning steps prior to the final rinse and drying steps.

In addition to the specific application of granulated polysilicon cleaning, rinsing and drying, there are other similar industrial applications where critical surface treatment, cleaning, rinsing, and/or drying of bulk parts or objects is required. This includes ball bearing manufacturing, various bead and media blast recycling, quartz glass recycling, and other processes where cleaning, rinsing and particularly drying are problematic.

In some embodiments, superheated water and/or saturated/superheated steam can be used to rinse and dry large quantities of polysilicon granules at rates exceeding 400 kg per hour in a single chamber design.

Saturated steam is steam that is in equilibrium with heated water (e.g., saturated water) at the same pressure. For example, at atmospheric pressure, water is boiled at 100 C, generating saturated steam and saturated water. If saturated steam is reduced in temperature while keeping the same pressure, it will condense to produce water droplets. For example, a saturated water contains as much thermal energy as it can without boiling. Conversely a saturated vapor contains as little thermal energy as it can without condensing.

Superheated steam is steam at a temperature higher than water's boiling point. If saturated steam is heated at constant pressure, its temperature will also remain constant as the steam becomes dry saturated steam. Continued heating will then generate superheated steam.

Superheated water is liquid water under pressure at temperatures between the usual boiling point (100° C.) and the critical temperature (374° C.). It is also known as subcritical water and pressurized hot water. Superheated water can be stable under high pressure, for example, by heating in a sealed vessel with a headspace, where the liquid water is in equilibrium with water vapor at the saturated vapor pressure. This is different with unstable superheating, which refers to water at atmospheric pressure above its normal boiling point and which has not boiled due to a lack of nucleation sites.

In some embodiments, the hyperbaric chamber and supply reservoir can operate, for example, at up to 16 bar and up to 200 C. For example, very high specific heat of water, 6 times greater than silicon, can be used to quickly and efficiently heat wet polysilicon granules using superheated/saturated water. The water can then be drained under pressure leaving hot parts and residual trapped superheated water.

In some embodiment, a specifically shaped and configured v-shaped carrier that funnels steam and water down and out of the chamber when the drain valve is opened. Since the smaller granules will concentrate at the bottom, escaping steam velocity increases at the bottom of the carrier to jet away excess retained water where the extra velocity is required. The liquid can be flashing to vapor as pressure is released and causing excess liquid to be jetted away. This process of using vapor to displace liquid from object surfaces is called Rapid Displacement Drying.

In some embodiments, remaining trapped water on the granules will be flashed to steam as the pressure reaches 1 bar due to the remaining heat in both the superheated water as well as the excess heat from the polysilicon as it cools to 100®C.

Optionally, inert gas such as nitrogen gas can be introduced into the chamber to prevent any air from oxidizing the silicon and also to assist with cool down and remove any remaining moisture. In the context of the present invention, an inert gas includes a gas that does not react with the polysilicon granules, e.g., does not oxidize the silicon. Thus an inert gas can include non-oxygen containing gas, such as nitrogen, or hydrogen.

After a specified cool down in nitrogen, the tray with the polysilicon is removed from the chamber and placed in a queue where it continues cool down before being loaded onto a conveyer belt.

In some embodiments, a rinsing and drying process comprises loading polysilicon granules into special V-shaped tray. The loaded tray is then loaded into hyperbaric CNX chamber. The chamber can be pre-filled and purged with steam (saturated or superheated) or nitrogen to remove air that could oxidize silicon. Afterward, the chamber is filled to full pressure with steam (saturated or superheated) from a supply reservoir. The water (saturated or superheated) is then introduced in shower mode to rinse and continue heating polysilicon. In some embodiments, the water is drained, for example, as the water flowing in shower mode, or after a certain level of water to submerge the silicon granules. After the chamber and the polysilicon reach a desired temperature, a slow drain is open to remove excess water. When water is completely drained, e.g., the water level is zero, a fast drain is open, preferably to atmosphere, to allow steam to vent through bottom. Steam (superheated or saturated, and preferably superheated to avoid wetting silicon) can be re-introduced to re-pressurize the chamber. The fast drain can again be open to further dry the silicon. The drying process can comprise vaporization of water droplets and/or direct displacement of trapped water, e.g., in droplet forms, down the drain with the escaping steam. Again, this drying method is called Rapid Displacement Drying (RDD). The RDD process can repeat as necessary to displace as much trapped water as possible.

Optionally, dry nitrogen can be introduced to purge chamber of steam, continue removing moisture, and cooling down to acceptable level before exposure to atmosphere. The tray can be removed from the chamber to recover the silicon.

In some embodiments, the present invention will be applied to similar cleaning, rinsing, and drying applications. The materials being processed may vary but the specific technical challenges remain identical. Furthermore, the apparatus configuration and process sequences will be similar.

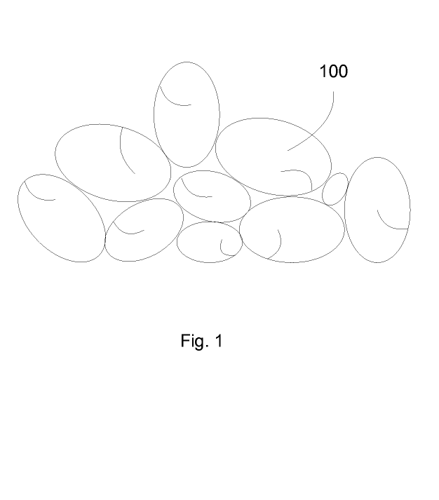

FIG. 1 illustrates an exemplary granulated polysilicon according to some embodiments. The granulated polysilicon 100 comprises crushed polysilicon fragments, which can be fed to a furnace to make, for example, single crystal silicon ingots.

In some embodiments, methods and apparatuses are disclosed for cleaning, rinsing and drying an object such as granulated polysilicon using hyperbaric pressure. Hyperbaric pressure process can significantly simplify the cleaning, rinsing and drying equipment, for example, by eliminating vacuum pumps or power during the cyclic process. In addition, hyperbaric pressure process can extend the temperature ranges, which can lead to faster reaction rates, increasing processing speed and cleaning effectiveness. Further, the consumables can be less expensive and more environment friendly, for example, water and stream at elevated temperatures can be used instead of highly reactive chemicals.

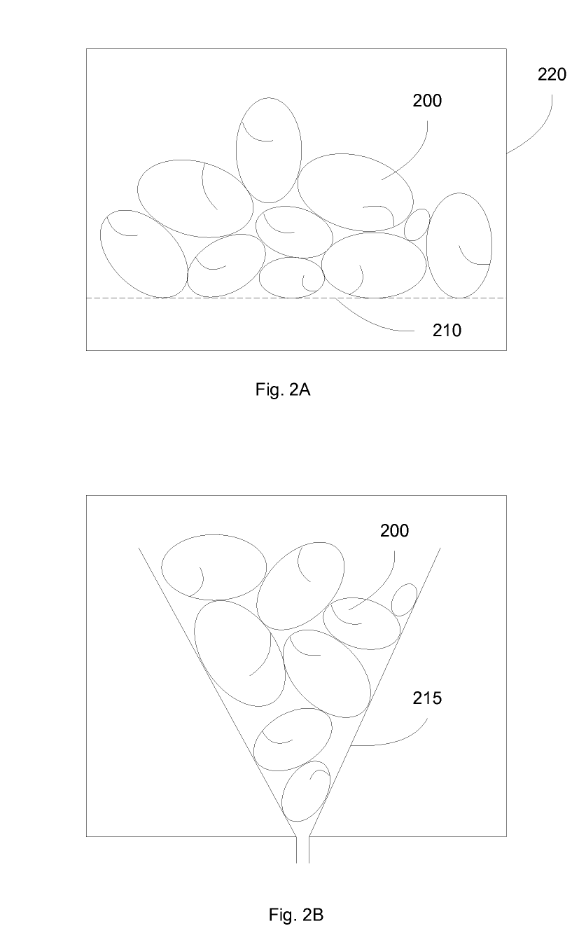

FIGS. 2A-2B illustrate exemplary configurations for practicing hyperbaric pressure processes according to some embodiments. In FIG. 2A, granulated polysilicon 200 is disposed on a mesh 210 within a sealed chamber 220. The sealed chamber 220 can enable high pressure environment within the interior of the chamber, such as up to 20 bar pressure. The mesh 210 can allow draining of liquid from the granulated silicon, so that the polysilicon can be dried. In FIG. 2B, the granulated polysilicon 200 is loaded in a V-shape tray 215, allowing liquid to drain from the polysilicon to the bottom of the tray. Other configurations can also be used, such as a mesh with multiple V-shape surfaces, which can allow liquid to be removed from the polysilicon.

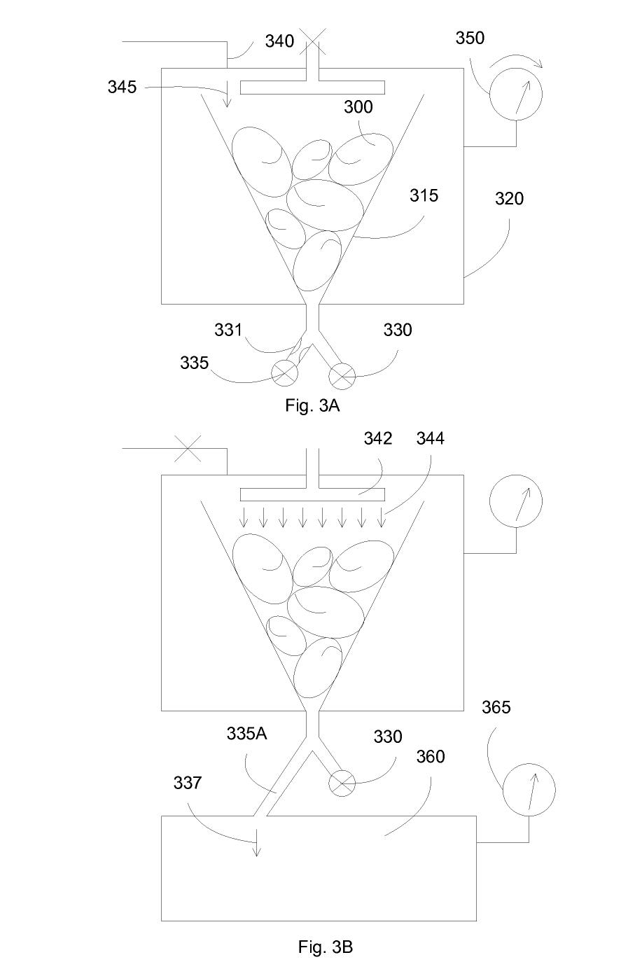

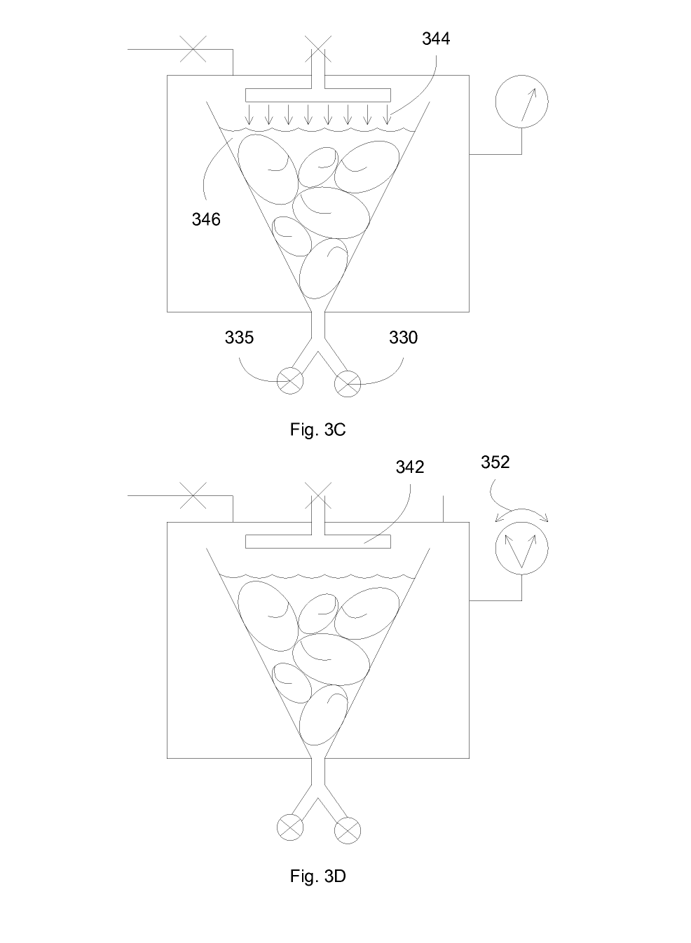

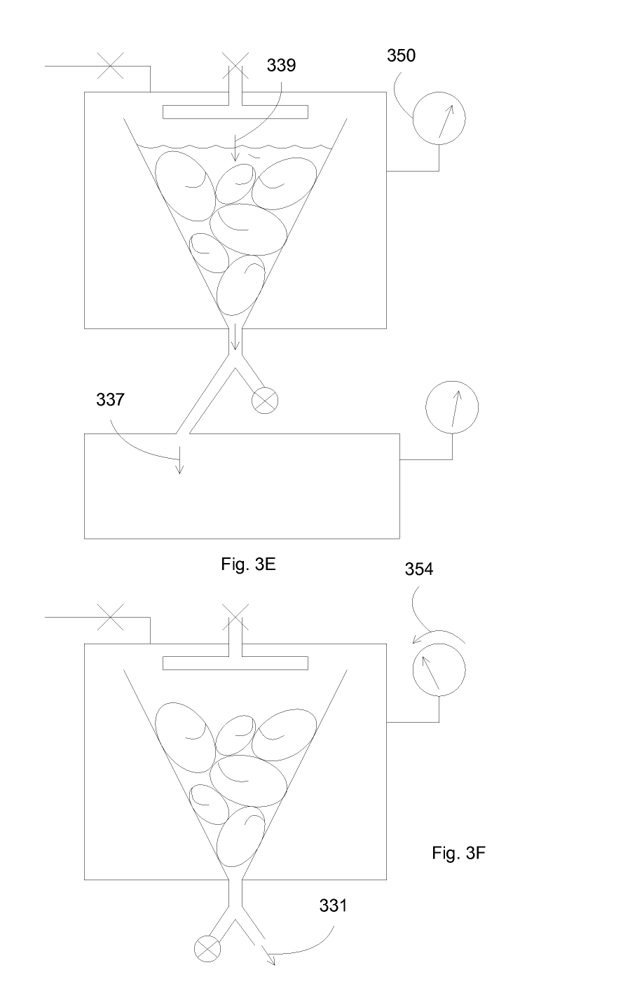

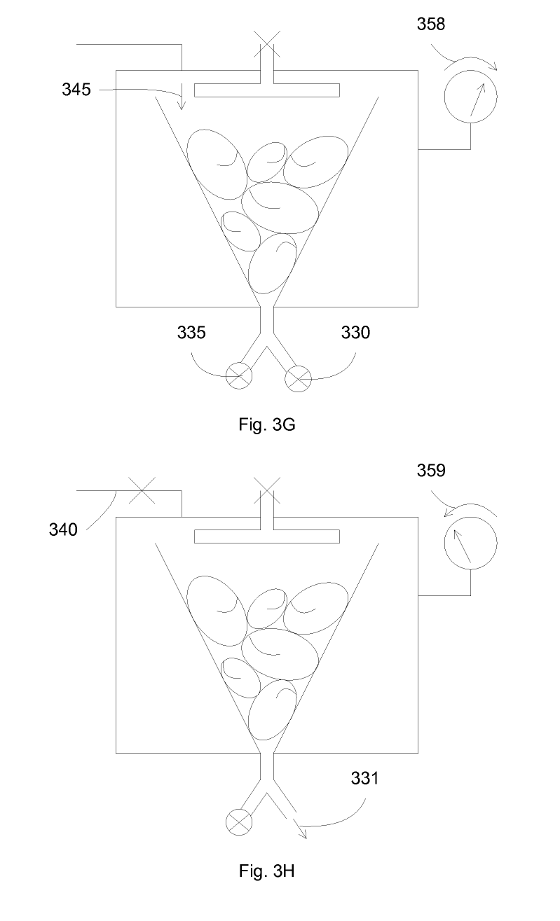

FIGS. 3A-3H illustrate an exemplary sequence of preparing granulated polysilicon according to some embodiments. In FIG. 3A, the granulated polysilicon 300 is loaded into a V-shape tray 315, which is disposed in a process chamber 320. The polysilicon can be loaded to the tray outside the chamber, and the loaded tray is then brought to the process chamber. Alternatively, the polysilicon can be brought to the tray, which is already position in the chamber. The chamber 320 also comprises drain valves 330 and 335, preferably coupled to the outlet of the tray 315, for example, to drain fluid (e.g., in liquid form or gas form) from the process chamber. An optional restrictor 331 can be coupled to the conduit of valve 335, allowing a slow draining from the process chamber 320. A gas inlet 340 is also coupled to the process chamber 320, for example, to deliver gas or vapor to the process chamber. In some embodiments, the inlet 340 is operable to deliver steam, saturated or superheated steam, to the process chamber. Chemicals can be mixed with the incoming steam to conditioning the polysilicon, such as hydrofluoric acid (HF) to remove silicon oxide from the surface of the polysilicon, or an oxygen gettering chemical to prevent the steam from oxidizing the polysilicon. Other chemicals can be included, such as a detergent or surfactant to clean the polysilicon.

After the polysilicon is loaded to the process chamber, and after the chamber has been conditioned to prevent oxidation of the polysilicon, such as purging the chamber with inert gas (e.g., nitrogen or argon), saturated or superheated vapor 345 is introduced to the process chamber to an operation pressure, for example, as indicated by a pressure gauge 350. The operation pressure is preferably above atmospheric pressure, for example, between 1 and 20 bar pressure. The vapor is preferably steam (heated water vapor), with or without added chemicals for polysilicon conditioning (e.g., cleaning, etching or preventing oxidation). The steam can also heat the polysilicon.

In FIG. 3B, after the process chamber reaches the operating pressure and/or temperature, the steam flow stops. Saturated or superheated liquid 344 is introduced, for example, heated water from a shower head 342. In some embodiments, the drain valve 335 is open (335A) to a pressurized container 360, as indicated by a pressure gauge 365. The heated water 344 can flow from the shower head, rinsing the polysilicon and then drain to the container 360. The heated water can also heat the polysilicon. Since the container is at similar pressure with the process chamber, there is no pressure loss in the process chamber. The container can be positioned below the process chamber, so that the liquid can be drained by gravity. The container can have pressure somewhat lower than that of the process chamber, so that the liquid is drained by the pressure difference. In some embodiments, the drain valve 335 can be open to atmosphere, releasing heated water. Alternatively, the drain valve 335 can be open to a heat exchanger to recover the heat.

In some embodiments, the drain valve 335 can be open intermittently. For example, after the heater water rinses the polysilicon and is collected at a certain level in the process chamber, the drain valve can then be opened to drain the collected water.

Optionally, the liquid can be retained for CNX cleaning FIGS. 3C-3D show an exemplary sequence for CNX cleaning of the polysilicon. In FIG. 3C, the drain valve 330 and 335 are close, and the heated liquid 344 from the shower head is collected 346 to immerse the polysilicon. The pressure chamber can be cycled 352, to generate and terminate bubbles in the liquid 346, which can clean the surfaces of the polysilicon.

In some embodiments, the nucleation cycling can be performed by varying pressure, for example, from a pressure higher than the boiling pressure of the liquid (and higher than atmospheric pressure in some embodiments) to a pressure lower than the boiling pressure of the liquid. At the pressure lower than the boiling point, the liquid starts to boil, generating bubbles. The process conditions are preferably controlled so that the bubbles are generated at the surface of an object that is at least partially submerged in the liquid. For example, at onset of boiling, the bubbles are mostly generated at the surfaces of the object, thus in some embodiments, the pressure reduction is controlled to maintain the onset of boiling condition, avoiding the rigorous boiling regime in which the bubbles are generated within the liquid.

In some embodiments, the energy in the heated liquid can be released in such a way to cyclically generate and terminate bubbles at the object surface, cleaning the object surface with the bubble energy. For example, by temporarily releasing the pressure of the liquid to below the boiling point, e.g., atmospheric pressure by opening a relief valve, the bubbles are generated. The pressure release process can be performed without actively acting on the temperature of the liquid, thus the liquid temperature can be unchanged or slightly changed, depending on the equipment and process. Then the pressure release is terminated, and equilibrium can be re-established. For example, the relief valve is close, and vapor pressure is built up to equilibrium. The equilibrium point is preferably above the boiling point, e.g., the liquid pressure is higher than the boiling pressure of the liquid temperature, and thus the bubbles are terminated, acting to clean the object surface, for example, by releasing the energy to the particulates adhering to the object surface. The process can be repeated until the object is cleaned, or until the internal energy is no longer adequate to perform the pressure cycling.

In FIG. 3E, the liquid 339 that is cleaning or rinsing the polysilicon is drained to the container while keeping the process chamber at high pressure, for example, due to the high temperature and high pressure steam. In FIG. 3F, the drain valve 330 is open, for example, to atmosphere, to quickly release the steam 331. The fast release of the steam can absorb energy from the environment, vaporizing and displacing any liquid droplets that remain on the polysilicon surface, and thus acts to dry the polysilicon. In addition, the fast release of the steam can push water, in liquid form, from the process chamber, especially the liquid at the vicinity of the drain valve.

Optionally, steam can be re-applied to and then released from the process chamber to additionally processing, e.g., drying, the polysilicon. In FIG. 3G, steam 345 is introduced to the process chamber while the drain valves 330 and 335 are close, raising the pressure 358 of the process chamber. In FIG. 3H, the drain valve 330 is quickly open, releasing the chamber pressure 359 and draining the steam 331. The fast release of the steam can further vaporize any remaining liquid droplets on the polysilicon. The Rapid Displacement Drying process can be repeated, for example, until the polysilicon is dried. Inert gas such as nitrogen can be introduced for cooling before remove the polysilicon to minimizing oxidation.

In some embodiments, superheated steam, i.e., dry steam, is used to fill the process chamber. Superheated steam is dry, and thus does not re-wet the polysilicon during the drying process. For example, the drying sequence can comprise filling the process chamber, containing wet polysilicon, with superheated steam to a high pressure (above atmospheric pressure). Then the steam is quickly released, vaporizing liquid on the polysilicon surface to dry the polysilicon.

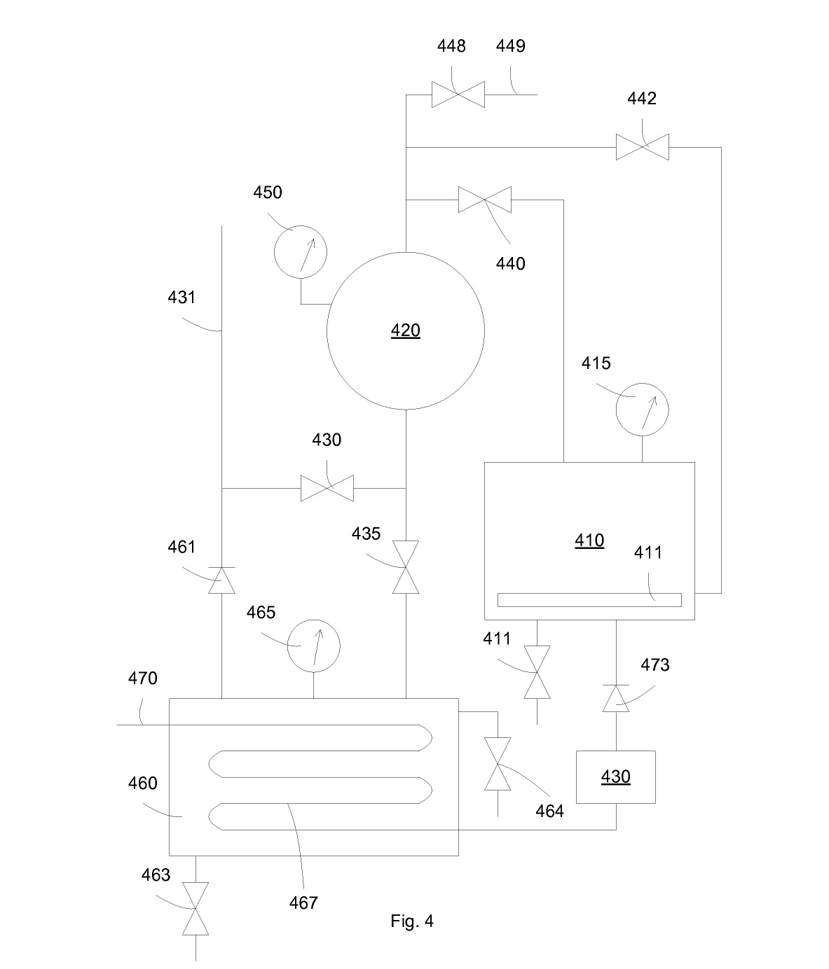

FIG. 4 illustrates an exemplary system configuration for a hyperbaric process according to some embodiments. A process chamber 420 can be used to clean, rinse and dry polysilicon. The process chamber can comprise a pressure gauge 450 to monitor the chamber pressure. The process chamber can comprise a plurality of inlets, coupled to valves for controlling the inlet flows. A gas inlet is controlled by gas valve 440, for example, to deliver saturated or superheated vapor such as steam to the process chamber. A liquid inlet is controlled by a liquid valve 442, for example, to deliver saturated or superheated liquid such as heated water to the process chamber. Another gas inlet is controlled by valve 448, for example, to deliver inert gas such as nitrogen 449 to the process chamber.

The process chamber can comprise outlet, such as a drainage, which can be controlled by valve 430 and 435 to provide different draining from the process chamber. For example, control valve 430 is coupled to vent line 431, operable to exhaust vapor from the process chamber to atmosphere. Control valve 435 is coupled to a container 460, which is preferable under pressure (monitored by pressure gauge 465), which is similar or slightly lower than the pressure of the process chamber. The container 460 can be operable to collect liquid, draining from the process chamber.

A reservoir 410 can be included to supply saturated or superheated liquid and/or vapor to the process chamber. The reservoir 410 can comprise a heater 411 to heat the liquid in the reservoir, preferably to a temperature and pressure above the boiling temperature and above atmospheric pressure. A pressure gauge 415 can be included to monitor the pressure of the reservoir. Heated liquid, e.g., saturated liquid or superheated liquid, can be delivered to the process chamber through control valve 442. Heated vapor, e.g., saturated vapor or superheated vapor, can be delivered to the process chamber through control valve 440.

The container 460 can comprise an optional heat exchanger 467, which can be operable to heat fresh liquid 470, for example to supply to the reservoir 410, through liquid pump 430 and check valve 473. The heat exchanger 467 can recycle wasted heat from the process chamber, utilizing the wasted heat from the drained liquid to heat fresh liquid. The container can comprise a number of outlets, for example, a dirty drain valve 463 coupled to a bottom of the container to drain any debris collected from the process chamber. Another drain valve 464 is coupled to a top portion of the container to prevent overflow of the container. An exhaust line coupled to a check valve 461 can be used to exhaust vapor to a vent line 431.

In some embodiments, the present invention discloses systems and processes for processing granulated polysilicon. An automation facility can be used to continuously process granulated polysilicon, for example, through an assembly line.

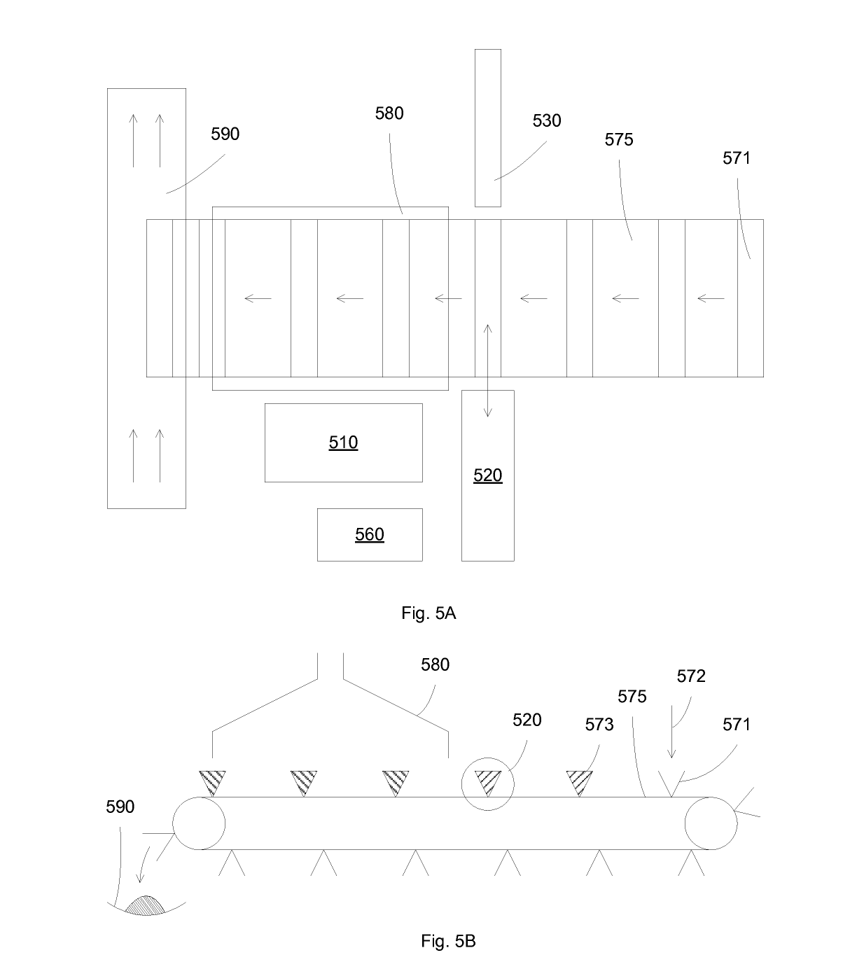

FIG. 5A-5B illustrate different views of an exemplary assembly line to process granulated polysilicon according to some embodiments. FIG. 5A shows a top view and FIG. 5B shows a cross section of the assembly line. A conveyor belt 575 carries a number of trays 571 from an supply 572 of granulated polysilicon to a delivery 590 to deliver clean and dry polysilicon, for example to a furnace. Loaded tray 573 is loaded into process chamber 520, for example, by loader 530. Reservoir 510 and waste container 560 can be included to provide services to the process chamber 520. A cool down station 580 having air or nitrogen gas shower can be included to cool the polysilicon after exiting the process chamber 520. At the end of the conveyor belt 575, the polysilicon is dump to a delivery 590, for example, another conveyor belt, to carry the polysilicon to a final destination, such as a furnace.

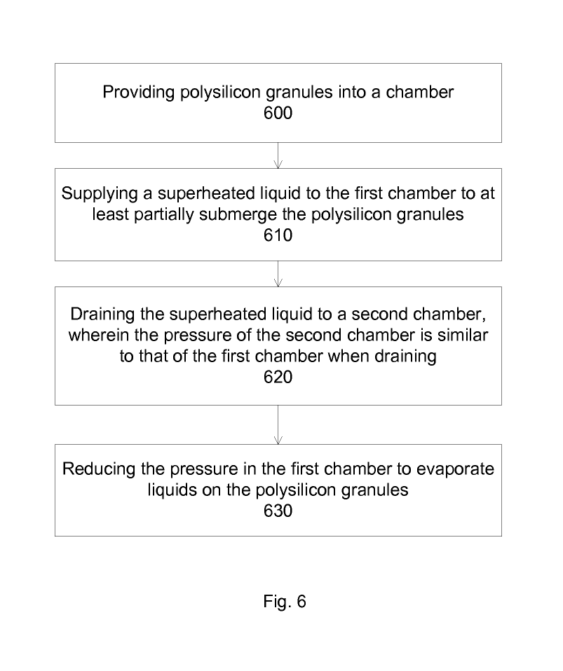

FIG. 6 illustrates a flow chart for a polysilicon granule cleaning process according to some embodiments. Operation 600 provides polysilicon granules into a chamber. For example, the polysilicon granules can be placed on a mesh or provided in a V-shape tray. In some embodiments, the chamber can be sealed and then brought up to a high pressure, e.g., above atmospheric pressure, after the polysilicon granules are loaded into the chamber. The high pressure can be similar to the pressure of a superheated liquid that will be introduced to the chamber for cleaning The high pressure condition can be established by a gas, such as an inert gas that does not oxidize the polysilicon, Alternatively, a superheated steam can be supplied to the chamber. The superheated steam can be generated together with the superheated liquid, and thus can have the same pressure.

In some embodiments, the polysilicon granules can be etched to remove any native oxide on the polysilicon surface. For example, a silicon oxide etch chemical, such as HF, can be introduced, together with the high pressure ambient, to clean the surface oxide from the granules. HF-containing vapor can be added to the superheated steam, so that the polysilicon granules can be exposed to an HF environment to remove the native oxide before cleaning.

In some embodiments, an oxygen inactive ambient, e.g., an ambient not containing oxygen or an ambient containing oxygen gettering materials, can be established in the chamber, for example to prevent oxidation of the polysilicon, especially after the native oxide has been removed, for example, after an HF exposure. Inert gas can be introduced to the chamber, or an oxygen gettering chemical can be introduced with the superheated steam.

Operation 610 supplies a superheated liquid to the first chamber to at least partially submerge the polysilicon granules. The superheated liquid can be partially drained during the supplying, as to provide an initial cleaning of the polysilicon. After an initial cleaning, the polysilicon can be submerged in the superheated liquid. A cyclic nucleation process can be performed to clean the polysilicon, especially in hard to get areas. Since the chamber pressure is above atmospheric, a chamber valve can be open to release the chamber pressure, thus generating bubbles in the liquid for cleaning. The valve can be close, and the pressure can be built up to terminate the bubbles. The valve can be cyclically open and close, which can cyclically releasing and stop releasing pressure in the chamber.

Operation 620 drains the superheated liquid to a second chamber, wherein the pressure of the second chamber is similar to that of the first chamber when draining. For example, the second chamber can have similar pressure, and thus the connection between the first and second chambers can be performed without significantly changing the pressure in the first chamber. In some embodiments, the process can be repeated, e.g., a superheated liquid can be repeatedly supplied and drained from the chamber, for example, to clean the polysilicon to a desired cleanliness.

Operation 630 reduces the pressure in the first chamber to evaporate liquids on the polysilicon granules. After the superheated liquid is drained, the chamber can contain superheated steam. A rapid release of the superheated steam can carry liquid droplets on the granular polysilicon, thus can effectively dry the polysilicon. In some embodiments, the process can be repeated, e.g., a new superheated steam can be re-supplied to the chamber, and then re-released for further drying. The new superheated steam can be dry superheated steam.

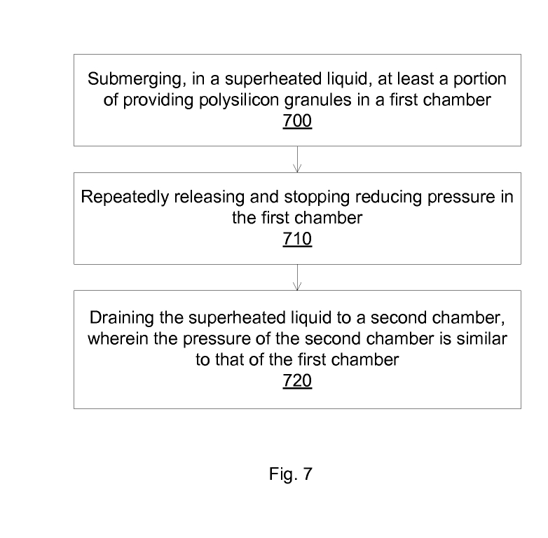

FIG. 7 illustrates another flow chart for a polysilicon granule cleaning process according to some embodiments. Operation 700 submerges, in a superheated liquid, at least a portion of providing polysilicon granules in a first chamber.

In some embodiments, the chamber can be sealed and then brought up to a high pressure, e.g., above atmospheric pressure, before submerging the polysilicon granules. The high pressure can be similar to the pressure of a superheated liquid that will be introduced to the chamber for cleaning. The high pressure condition can be established by a gas, such as an inert gas that does not oxidize the polysilicon, Alternatively, a superheated steam can be supplied to the chamber. The superheated steam can be generated together with the superheated liquid, and thus can have the same pressure.

In some embodiments, the polysilicon granules can be etched to remove any native oxide on the polysilicon surface. For example, a silicon oxide etch chemical, such as HF, can be introduced, together with the high pressure ambient, to clean the surface oxide from the granules. HF-containing vapor can be added to the superheated steam, so that the polysilicon granules can be exposed to an HF environment to remove the native oxide before cleaning.

In some embodiments, an oxygen inactive ambient, e.g., an ambient not containing oxygen or an ambient containing oxygen gettering materials, can be established in the chamber, for example to prevent oxidation of the polysilicon, especially after the native oxide has been removed, for example, after an HF exposure. Inert gas can be introduced to the chamber, or an oxygen gettering chemical can be introduced with the superheated steam.

In some embodiments, the process can be repeated, e.g., a superheated liquid can be repeatedly supplied and drained from the chamber, for example, to clean the polysilicon to a desired cleanliness

Operation 710 repeatedly releases and stops reducing pressure in the first chamber. A cyclic nucleation process can be performed to clean the polysilicon, especially in hard to get areas. Since the chamber pressure is above atmospheric, a chamber valve can be open to release the chamber pressure, thus generating bubbles in the liquid for cleaning. The valve can be close, and the pressure can be built up to terminate the bubbles. The valve can be cyclically open and close, which can cyclically releasing and stop releasing pressure in the chamber.

In some embodiments, a new superheated liquid can be provided to the chamber, after draining the existing superheated liquid. The cyclic nucleation process can be repeated. In some embodiments, a new superheated liquid can be provided to the chamber to bring the chamber to a high pressure before moving to the next step of draining the liquid while keeping the high pressure.

Operation 720 drains the superheated liquid to a second chamber, wherein the pressure of the second chamber is similar to that of the first chamber. After the superheated liquid is drained, the chamber can contain superheated steam. A rapid release of the superheated steam can carry liquid droplets on the granular polysilicon, thus can effectively dry the polysilicon. In some embodiments, the process can be repeated, e.g., a new superheated steam can be re-supplied to the chamber, and then re-released for further drying. The new superheated steam can be dry superheated steam.

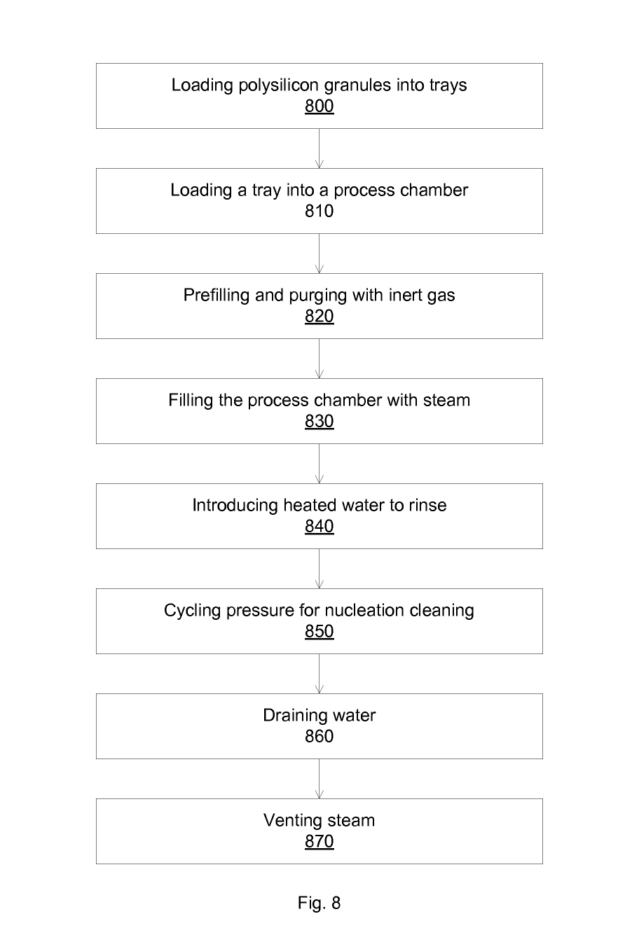

FIG. 8 illustrates an exemplary flow chart for a hyperbaric process for cleaning, rinsing and drying granulated polysilicon according to some embodiments. Operation 800 loads polysilicon granules into trays, such as mesh trays or v-shape trays. Operation 810 loads a tray into a process chamber. Alternatively, empty trays can be positioned in the chamber and the polysilicon are brought on the trays. Operation 820 optionally prefills and purges the process chamber with inert gas, such as nitrogen or with superheated or saturated steam. Operation 830 fills the process chamber with steam, such as saturated or superheated steam from a supply reservoir. Operation 840 introducing heated water, such as saturated or superheated water, to rinse. The heated water (saturated or superheated) can be introduced in shower mode to rinse and continue heating polysilicon. In some embodiments, the water is drained, for example, as the water flowing in shower mode, or after a certain level of water to submerge the silicon granules. The water can comprise chemicals for cleaning or etching, such as HF for removing native oxide on the polysilicon. Operation 850 optionally cycles pressure for nucleation cleaning Operation 860 drains water. The drain can be a slow drain, and can be performed without a loss of pressure in the chamber. For example, by draining to a container having similar pressure, liquid can be removed from the chamber without significantly affecting the vapor pressure. In some embodiments, a new superheated liquid can be supplied to the chamber to raise the pressure of the chamber. For example, if the existing pressure is low, e.g., due to the cyclic pressure release, a new superheated liquid can be supplied to bring back the pressure. Then the new superheated liquid can be drained, with remaining high pressure in the chamber. Operation 870 vents the steam, for example, through a fast vent, e.g., larger conductance than the slow liquid drain. If the chamber pressure is high, the steam venting can dry the liquid droplets, due to a rapid change of pressure. A new superheated steam can be re-introduced and re-vent for further drying the polysilicon. The drying process can comprise vaporization of water droplets and/or direct displacement of trapped water, e.g., in droplet forms, down the drain with the escaping steam. The process can repeat as necessary to displace as much trapped water as possible.

Optionally, dry nitrogen can be introduced to purge chamber of steam, continue removing moisture, and cooling down to acceptable level before exposure to atmosphere. The tray can be removed from the chamber to recover the silicon.

The above description uses granular polysilicon as an example of materials can be cleaned and dried. But the invention is not limited to polysilicon, and can be equally suitable for other materials, such as ball bearing manufacturing, various bead and media blast recycling, quartz glass recycling, and other materials where cleaning, rinsing and particularly drying are problematic.

What is claimed is:

1. A method for cleaning granular silicon-containing materials, the method comprising
providing silicon-containing granules into a first chamber;
supplying a superheated liquid to the first chamber to at least partially submerge the silicon-containing granules;
draining the superheated liquid to a second chamber, wherein the pressure of the second chamber is similar to that of the first chamber when draining;
reducing the pressure in the first chamber to evaporate liquids on the silicon-containing granules.

2. A method as in claim 1 wherein the silicon-containing granules are provided in a V-shape tray.

3. A method as in claim 1 further comprising
establishing a first pressure in the first chamber after providing the silicon-containing granules in the first chamber,
wherein the first pressure is similar to the pressure of the superheated liquid.

4. A method as in claim 1 further comprising
supplying a superheated steam to the first chamber after providing the silicon-containing granules in the first chamber.

5. A method as in claim 4 further comprising
adding a chemical to the superheated steam,
wherein the chemical comprises HF or an oxygen-gettering chemical.

6. A method as in claim 1 further comprising
establishing an oxygen-inactive ambient in the first chamber after providing the silicon-containing granules in the first chamber.

7. A method as in claim 1 further comprising
repeating supplying and draining the superheated liquid.

8. A method as in claim 1 further comprising
cyclically releasing and stopping releasing pressure in the chamber before draining the superheated liquid.

9. A method as in claim 1 further comprising
supplying a superheated steam to the first chamber after reducing the pressure in the first chamber.

10. A method for cleaning granular silicon-containing materials, the method comprising
submerging, in a superheated liquid, at least a portion of providing silicon-containing granules in a first chamber;
repeatedly releasing and stopping reducing pressure in the first chamber;
draining the superheated liquid to a second chamber, wherein the pressure of the second chamber is similar to that of the first chamber.

11. A method as in claim 1 further comprising
supplying a superheated steam to the first chamber before supplying the superheated liquid to the chamber for submerging the silicon-containing granules.

12. A method as in claim 11 further comprising
adding a chemical to the superheated steam,
wherein the chemical comprises HF or an oxygen-gettering chemical.

13. A method as in claim 10 further comprising
establishing an oxygen-inactive ambient in the first chamber before supplying the superheated liquid to the chamber for submerging the silicon-containing granules.

14. A method as in claim 10 further comprising
draining the superheated liquid;
supplying another superheated liquid to the chamber for submerging the silicon-containing granules.

15. A method as in claim 10 further comprising
reducing the pressure in the first chamber to evaporate liquids on the silicon-containing granules.

16. A method as in claim 10 further comprising
supplying a superheated steam to the first chamber after reducing the pressure in the first chamber.

17. A system for cleaning granular silicon-containing materials, the system comprising
a sealable first chamber,
wherein the first chamber comprises a first inlet and a first outlet,
wherein the first inlet is configured to accept a superheated liquid,
wherein the outlet is configured to release a superheated liquid;
a support,
wherein the support is positioned in the first chamber;
wherein the support is configured to support silicon-containing granules,
wherein the first inlet is positioned at a top of the support,
wherein the first outlet is positioned at a bottom of the support;
a sealable second chamber,
wherein the second chamber is coupled to the first chamber through a valve coupled to the first outlet,
wherein the second chamber is configured to receive superheated liquid from the first chamber when the valve is open,

18. A system as in claim 17
wherein first chamber further comprises a second outlet,
wherein the second outlet is position at a bottom of the support,
wherein the second outlet is configured to release a pressure from the first chamber,
wherein the conductance of the second outlet is larger than that of the first outlet.

19. A system as in claim 17
wherein first chamber further comprises a second inlet,
wherein the second inlet is position at a top of the support,
wherein the second inlet is configured to accept a superheated steam.

20. A system as in claim 17 further comprising
a reservoir, wherein the reservoir is configured to supply the superheated liquid to the first inlet, and wherein the reservoir is configured to supply the superheated steam to the second inlet.
